(19) United States
(12) Patent Application Publication
(10) Pub. No.: US 2014/0123831 A1
(43) Pub. Date: May 8, 2014

(54) Drum Hoop Clamp

(71) Applicant: Ronn Dunnett, Delta (CA)

(72) Inventor: Ronn Dunnett, Delta (CA)

(21) Appl. No.: 13/797,198

(22) Filed: Mar. 12, 2013

Related U.S. Application Data
(60) Provisional application No. 61/722,706, filed on Nov. 5, 2012.

(51) Int. Cl. F16B 2/10

(52) U.S. Cl. CPC F16B 2/10
USPC 84/411 R

(57) ABSTRACT

A drum hoop clamp is disclosed herein. The drum hoop clamp being removably attached to a metal hoop or rim of a drum and allowing for positionable attachment of a drum accessory thereto. One example of the drum hoop clamp allowing for rotational positioning of the accessory relative to the drum hoop.

### BACKGROUND OF THE DISCLOSURE

1. Field of the Disclosure

This disclosure relates to the field of accessory clamps for percussion drums having a hoop and rim on the edge thereof.

2. Summary of the Disclosure

Disclosed herein is a drum hoop clamp for removable and positionable attachment of a drum accessory to the rim/counter hoop/head/flesh hoop of a drum without modification of the drum. The drum hoop clamp comprising: an inner body comprising a flesh hoop claw extending therefrom wherein the flesh hoop claw engages a longitudinally inward side of the drum hoop and drum head; a counter hoop claw longitudinally positionable to the flesh hoop claw wherein the counter hoop claw engages a longitudinally outward side of the drum hoop; a drum bolt providing compression force between the flesh hoop claw and the counter hoop claw; and an accessory clamp attached to the inner body and providing a clamping force about a portion of a drum accessory.

The drum hoop clamp as recited above may further comprise a pivoting mechanism between the inner body and the accessory clamp providing an axis of rotation about a radial axis of the drum.

### BRIEF DESCRIPTION OF THE DRAWINGS

FIG. 1 is an isometric environmental view of an accessory attached to the disclosed drum hoop clamp.

FIG. 1a is a photograph of the apparatus shown in FIG. 1.

FIG. 2 is an isometric environmental view of the accessory of FIG. 1 from a different angle attached to the disclosed drum hoop clamp.

FIG. 2a is a photograph of the apparatus shown in FIG. 2.

FIG. 3 is an isometric environmental view of another accessory attached to the disclosed drum hoop clamp.

FIG. 3a is a photograph of the apparatus shown in FIG. 3.

FIG. 4 is an isometric environmental view of a floor tom leg accessory attached to the disclosed drum hoop clamp.

FIG. 4a is a photograph of the apparatus shown in FIG. 3a.

FIG. 5 is an isometric environmental view of a base drum leg/spur attached to the disclosed drum hoop clamp.

FIG. 5a is a photograph of the apparatus shown in FIG. 5.

FIG. 6 is an isometric line art view of one example of the accessory clamp removed from the drum and accessory.

FIG. 7 is an isometric view of the example shown in FIG. 6 from a different angle.

FIG. 8 is an isometric view of several components of the example shown in FIG. 6.

FIG. 9 is an isometric view of several components of the example shown in FIG. 6.

FIG. 10 is an isometric view of the disclosed drum hoop clamp with a radial rotation mechanism.

FIG. 11 is a side exploded view of the example shown in FIG. 10.

FIG. 12 is a view of the example shown in FIG. 11 attached to a drum hoop.

FIG. 13 is a side cutaway view of a prior art drum and hoop.

### DESCRIPTION OF THE PREFERRED EMBODIMENTS

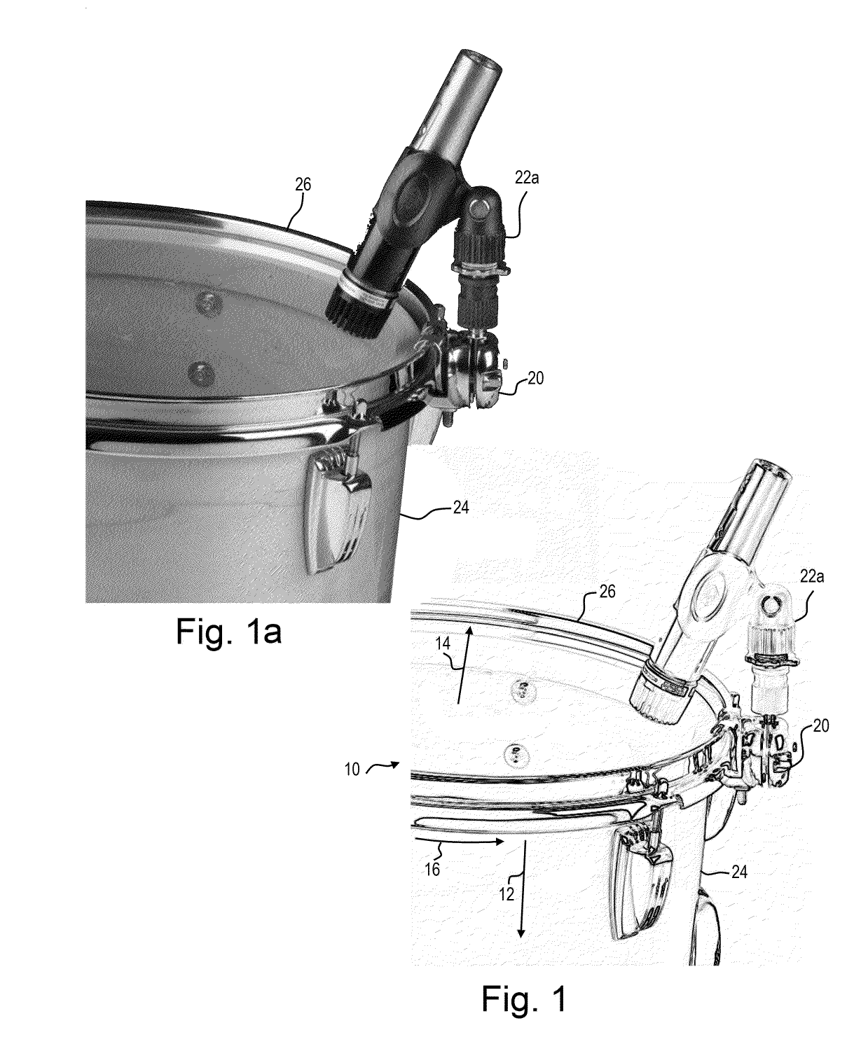

Before beginning a detailed description, an axes system 10 is shown in FIG. 1 generally comprising a radial axis 14 aligned perpendicular to the long axis of the drum toward the outer edge of the drum in a radial direction. Also shown is a longitudinal axis 12 generally parallel to the long axis of the drum. Also disclosed is a circumferential direction 16 aligned with the circumference of the outer side of the drum. It is to be understood that the drum in general operates in several orientations and is not limited to a particular positioning. These axes are used to aid in description only.

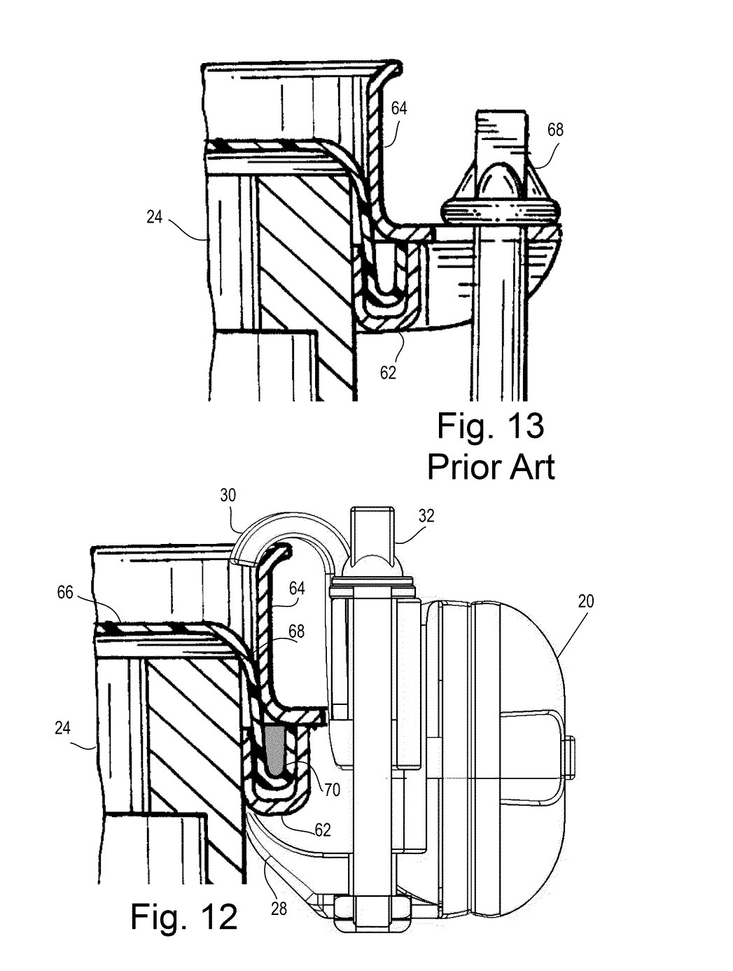

Looking to FIG. 1 is shown a drum hoop clamp 20 which is removably attached to the metal hoop 26 and flesh hoop 62 of a drum 24. The hoop 26 generally comprises a counter hoop 64 and flesh hoop 62 as seen in FIG. 12. As can be seen in FIG. 12, the drumhead 66 is stretched positioned over the rim 68 of the drum, the counter hoop 64 is positioned thereupon, and the hoop (drum) bolts 68 tensioned to tighten (tune) the drum. In one example, the flesh hoop is u-shaped in cross section, and the edge of the drumhead 66 is positioned in this U. In one form, adhesive 70 such as epoxy may fill the U portion of the flesh hoop 62 and substantially permanently adhere the drum head 66 to the flesh hoop 62. The drum hoop clamp 20 is provided for attachment of an accessory 22 such as the microphone accessory 22a shown in FIG. 1.

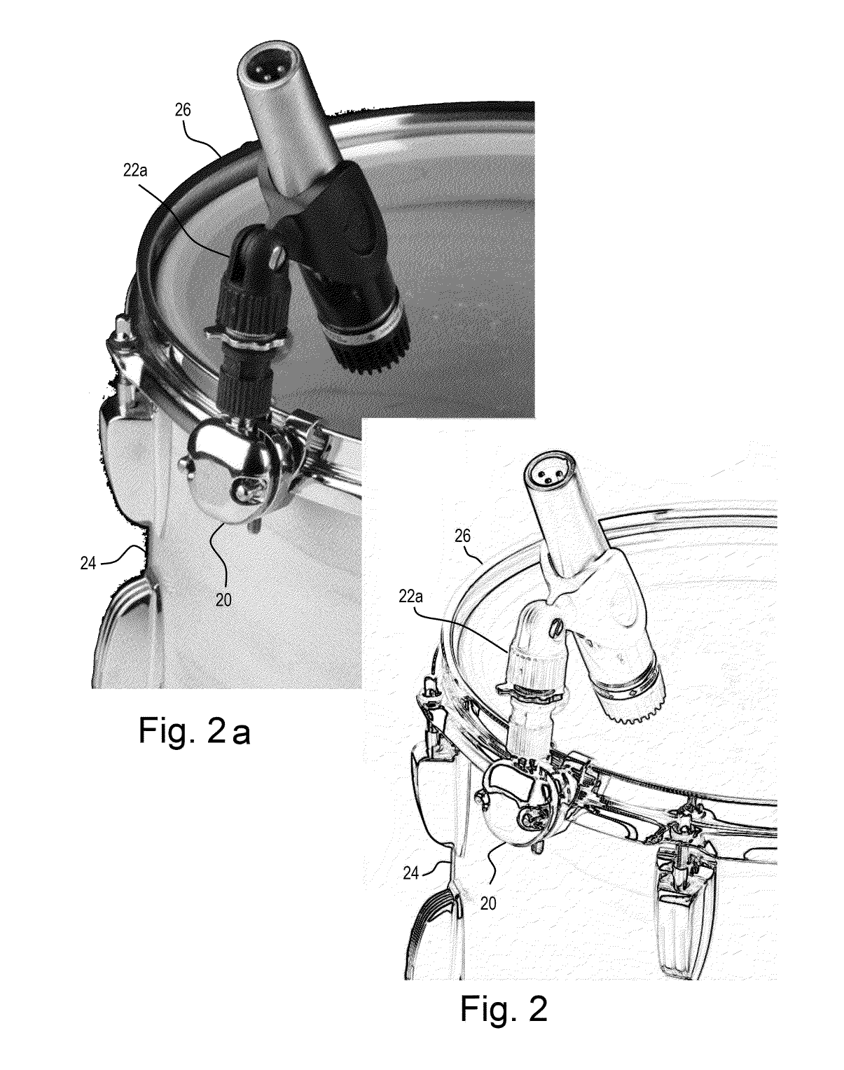

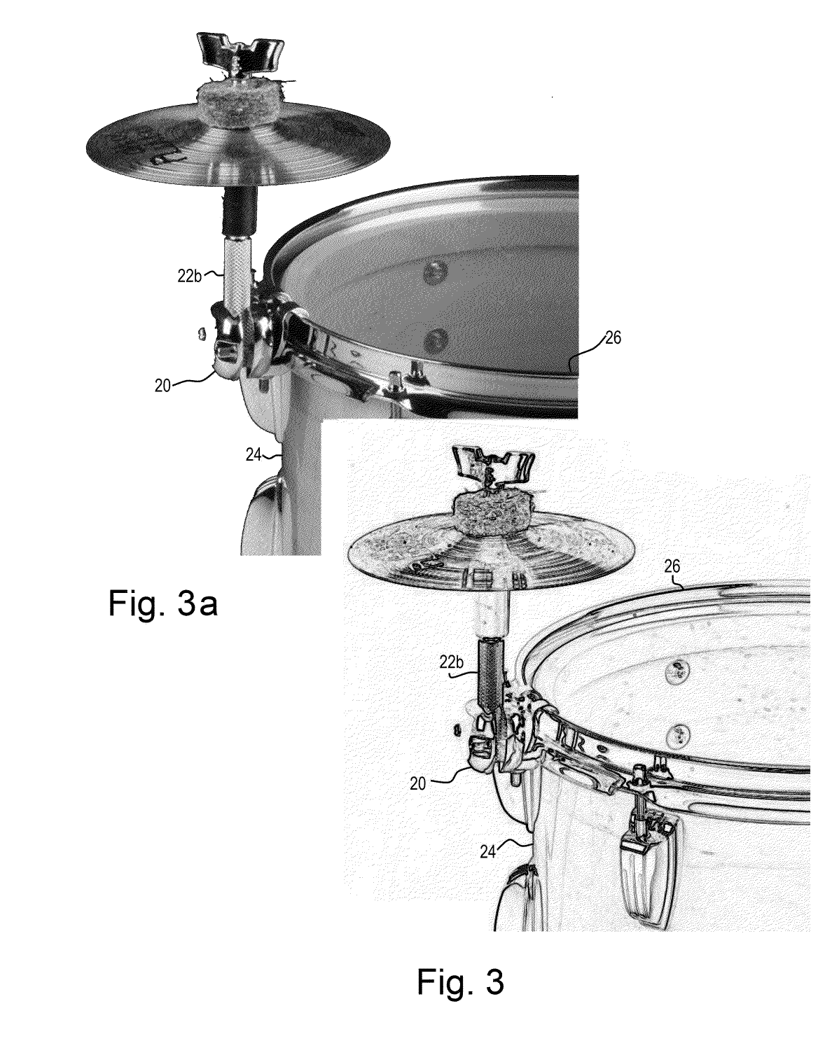

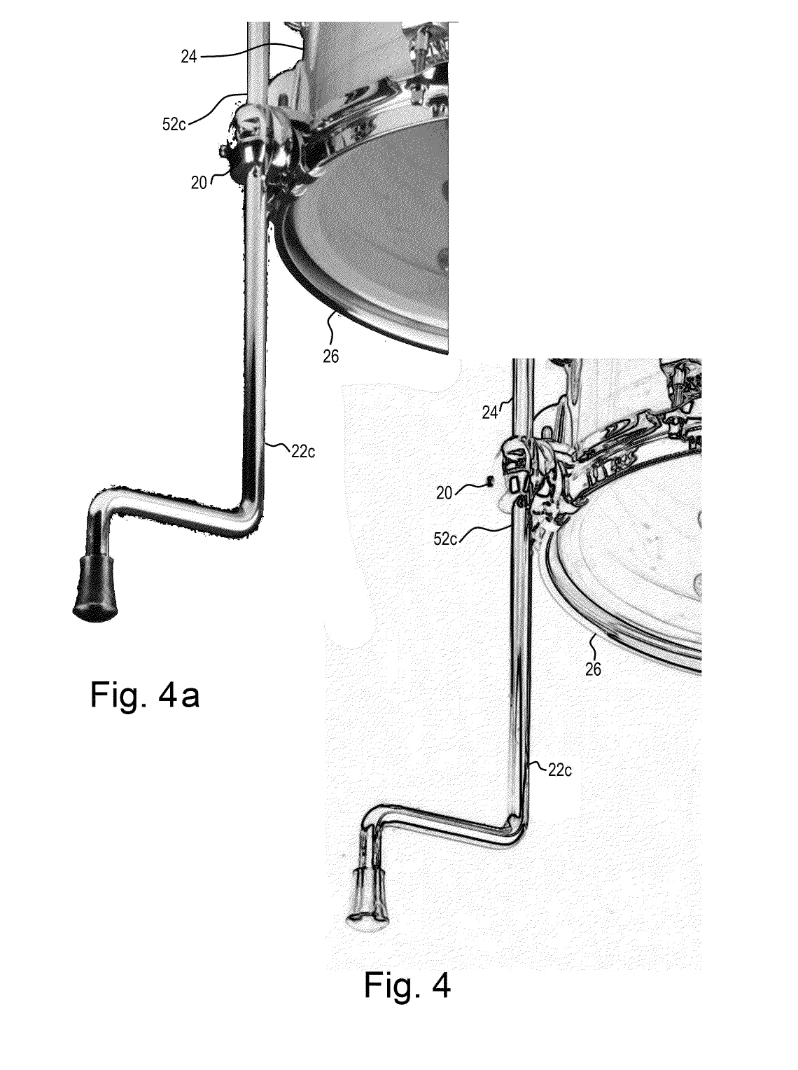

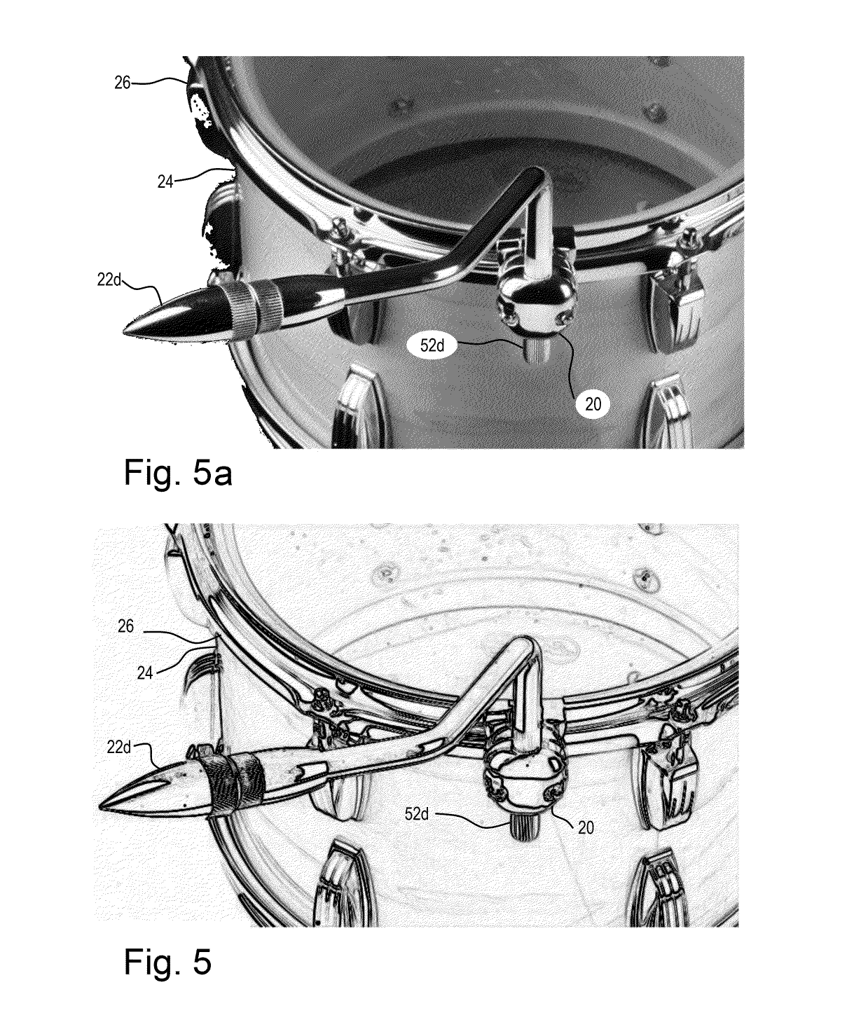

A numbering system is used herein wherein a general element such as an accessory will be labeled with a numeric prefix and particular variations on this component will be labeled with an alphabetic suffix. For example, an accessory is generally labeled 22, while the microphone accessory shown in FIGS. 1-2 is labeled 22a, the cymbal accessory 22b shown in FIGS. 3, 3a, the leg/foot accessory 22c shown in FIGS. 4, 4a, and the base drum leg/spur accessory 22d shown in FIGS. 5, 5a.

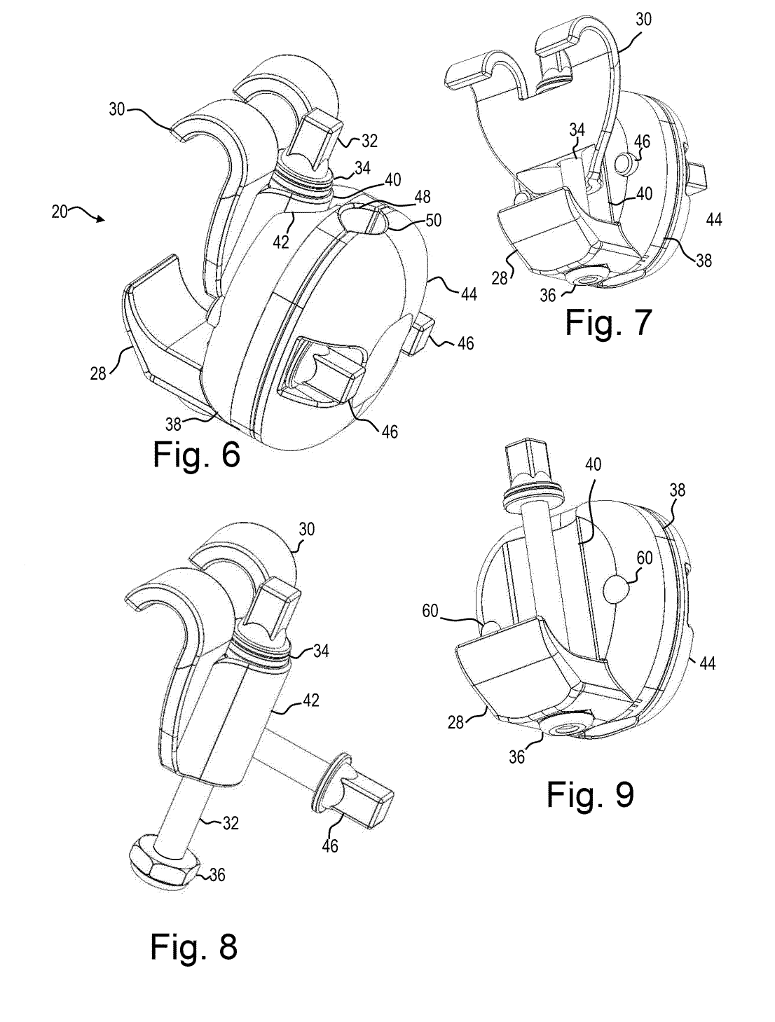

Looking to FIG. 6, the drum hoop clamp 20 is shown removed from the drum 24 and having all accessories 22 removed therefrom. In this view, it can be seen that the drum hoop clamp comprises a flesh hoop claw 28 which engages a longitudinally inward portion of the flesh hoop 62. By attachment to a longitudinally inward side of the drum hoop, a more secure attachment can be made than simply attaching to the drum hoop. For example, in FIGS. 1-3a, and FIGS. 5-5a the flesh hoop claw 28 engages the lower/inward portion of the hoop 26 while in FIGS. 4 and 4a, the counter hoop claw 30 engages the upper portion of the hoop 26. To encompass all disclosed variations, the portion of the hoop 26 closest the center of the drum has been termed longitudinally inward while the opposing side has been termed longitudinally outward. The longitudinally outward portion is sometimes called the rim (68 of FIG. 12). Going back to FIG. 6, a counter hoop claw 30 is provided which moves longitudinally in reference to the flesh hoop claw 28 and provides clamping force there between as a drum bolt 32 is rotated in a first direction which is normally clockwise (given a drum bolt 32 with right hand threads). In this example, the drum bolt 32 passes through a surface defining a non-threaded void 34 and engages a nut 36 which is fixed from rotation within the hoop claw 28. In this way, as the drum bolt 32 is rotated in a clockwise direction, the counter hoop claw 30 is drawn toward the flesh hoop claw 28 and when tensioned provides clamping (compression) force there upon. This non-elastic clamping force from both sides of the hoop 26 holds the drum hoop clamp 20 in place fixedly and rigidly upon the drum hoop 26. Non-elastic meaning that the force can be easily adjusted. Non-elastic clamps are not equivalent to spring clamps where the clamping force is a function of the spring tension/compression. This is particularly useful in drums 24 comprised of metal flesh hoops 62 and metal counter hoops 64 (see FIG. 12) which are significantly more resilient to deformation than plastic or wooden hooped drums. Also, with many spring compression clamps found in the art, it is often quite a simple matter to rotate, or otherwise remove the clamp by overcoming the spring tension.

In another example, the flesh hoop claw 28 may have a threaded surface provided there in providing the function of the nut 36 to be satisfied by the threaded surface.

In another example, the nut 36 is a rotation preventative nut such as a nut having a nylon insert therein.

FIG. 6 also shows an inner body 38 having the flesh hoop claw 28 extend there from wherein the inner body 38 provides a concave slide surface 40 which engages and allows passage of a convex slide surface 42 of the rim claw 30. In this example, an outer body 44 is positionally attached to the inner body 38 by way of a plurality of drum bolts 46. In this example, the inner body 38 comprises a concave surface 48 in opposition to a concave surface 50 of the outer body and wherein these concave surfaces 48/50 cooperate to clamp about a clamping portion 52 (see FIG. 11) of the accessory to be held in place by the drum hoop clamp 20. This clamping arrangement is shown in FIG. 5, where the clamping portion 52d can be very easily seen relative to the drum hoop clamp 20. The clamping portion 52c of the example shown in FIG. 4 can also be very easily seen. As the drum bolts 46 are rotated clockwise (given right hand threads) the space between the surfaces 48/50 decreases and a rigid compression clamping can be accomplished upon the accessory there between. The drum bolts 46 may be received by surfaces defining threaded voids 60, or threaded nuts may be provided in a similar manner to the nuts 36 previously disclosed.

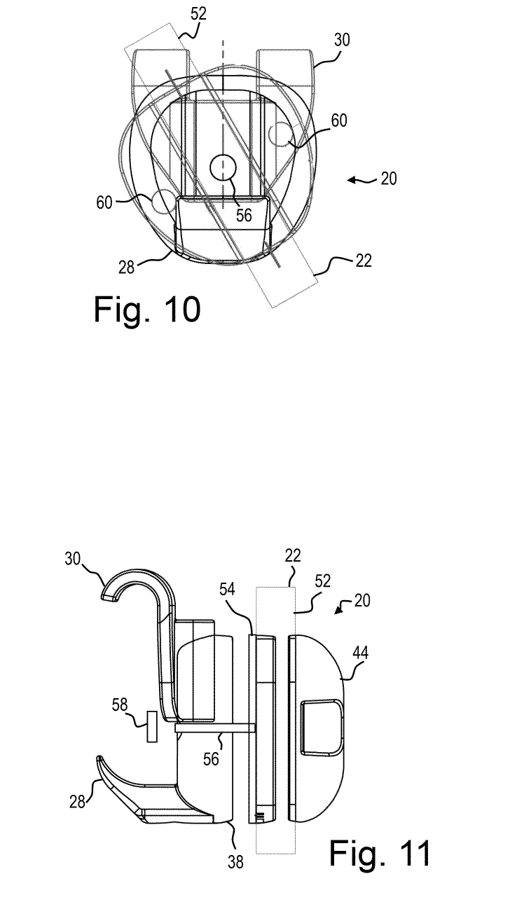

Looking to FIGS. 10-11, additional components are easily seen, including a rotational body 54 positioned between the outer body 44 and the inner body 38. This rotational body 54 in one example is fastened to the outer body 44 through drum bolts 46 which do not pass into the inner body 38 and the drum bolts 46 provide the clamping function to the clamping portion 52 of an accessory 22. The rotational body 54 it is also rotatably coupled to the inner body 38 such as by way of a shaft 56 which may be fixedly attached to the rotational body 54 and extend through the inner body 38 whereupon a nut 58 is provided (and recessed) on the radially inward side thereof. Alternatively, the shaft 56 may be exposed through a surface defining a void through the outer body 44 to allow tensioning of the shaft 56 from the radially outer side once the correct rotational orientation is achieved.

This arrangement provides a modular system for a single clamping apparatus to be used with multiple accessories such as the microphone mount 22a of FIG. 1, the cymbal mount 22b of FIG. 3, the floor tom leg 22c of FIG. 4, the base drum leg/spur 22d of FIG. 5, cowbell mounts, drum to drum connectors, etc.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A drum hoop clamp for removable and positionable attachment of a drum accessory to the rim of a drum hoop without modification of the drum hoop, the drum hoop clamp comprising:
a. an inner body comprising a flesh hoop claw extending therefrom wherein the hoop claw engages a longitudinally inward side of the drum hoop;
b. a counter hoop claw longitudinally positionable to the flesh hoop claw wherein the rim claw engages a longitudinally outward side of the drum hoop;
c. a drum bolt providing compression force between the flesh hoop claw and the counter hoop claw;
d. an accessory clamp attached to the inner body and providing a clamping force about a portion of a drum accessory.

2. The drum hoop clamp as recited in claim 1 further comprising:
a. a pivoting mechanism between the inner body and the accessory clamp;
b. the pivoting mechanism providing an axis of rotation about a radial axis of the drum; and
c. the pivoting mechanism providing rotation of the accessory clamp to the inner body.

3. The drum hoop clamp as recited in claim 1 wherein the drum hoop comprises a counter hoop and cooperating flesh hoop wherein the flesh hoop claw clamps against the flesh hoop and the counter hoop claw clamps against the counter hoop.

4. The drum hoop clamp as recited in claim 3 wherein the counter hoop and flesh hoop are metal.
